(19) United States
(12) Patent Application Publication
(10) Pub. No.: US 2005/0122640 A1
(43) Pub. Date: Jun. 9, 2005

(54) Device for heating cold parts with a high thermal mass

(76) Inventors: Michael Frank, Uttenreuth (DE); Peter van Hasselt, Erlangen (DE)

Correspondence Address: STAAS & HALSEY LLP, SUITE 700, 1201 NEW YORK AVENUE, N.W., WASHINGTON, DC, 20005, US

(21) Appl. No.: 10/503,060

(22) PCT Filed: Jan. 30, 2003
(86) PCT No.: PCT/DE03/00261

(30) Foreign Application Priority Data
Jan. 31, 2002 (DE) 102 03 789.2

(51) Int. Cl. H02H 7/00

(52) U.S. Cl. 361/19

(57) ABSTRACT

Cold parts with a high thermal mass are heated by an electric heating system connectable to an external heating current source and arranged in a thermally insulating cryostat housing for superconductive coils. The electric heating system may be an ohmic heating system mounted parallel to the superconductive coils. The heating current source is an A.C. power source connected to external superconductive feed lines.

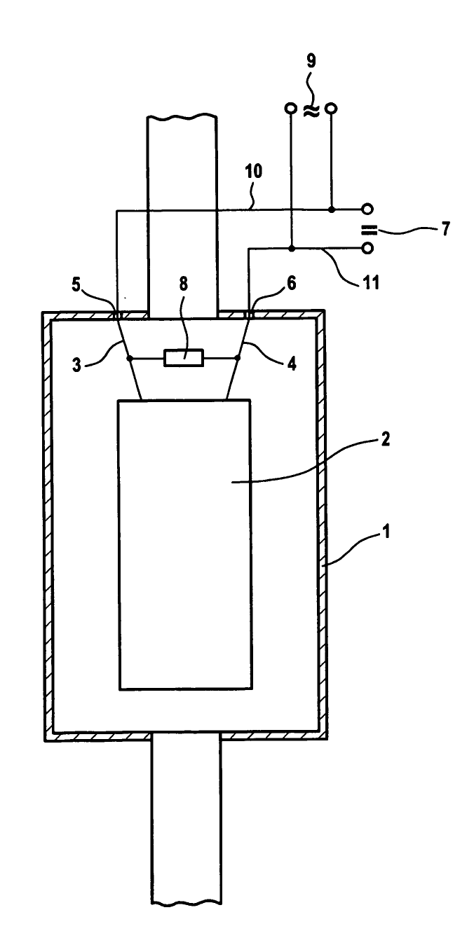

The invention relates to an apparatus for heating cold parts having a high thermal mass which are arranged in a thermally insulating cryostat housing for superconducting windings, having an electric heater which may be connected to an external heater current source and is arranged in the cryostat housing.

When using superconducting windings, the cold part must be designed such that it is effectively thermally insulated with respect to the exterior in order to prevent thermal losses (cryostat). For example, the losses for a cryostat having a length of approximately 80 cm and a diameter of 30 cm are easily markedly below 30 W. If maintenance work is required on the cold part, its temperature must be brought from the operating temperature, for example 20 K, to room temperature. If, for this purpose, only the thermal losses which are necessarily minimized for operation and are of the abovementioned order of magnitude are available, heating times on a scale of weeks results, which is of course not tolerable for practical operation. In order to be able to accelerate the heating process, electric heaters are therefore incorporated in the cold part in order to provide additional heating power where necessary. These heaters naturally have to be supplied with electrical power from the outside.

The design is generally such that the connections of the electric heater are led out of the cryostat interior to the outside by means of vacuum bushings. In addition to the power supply lines for the actual coil windings, additional bushings for the heaters are therefore also required. Each vacuum bushing, however, entails additional complexity and thus costs. Furthermore, in the interest of maintaining a static vacuum (if necessary over years), and also of minimizing the heat losses increased by each bushing, the number of bushings should be kept as low as possible.

The invention is therefore based on the object of designing an apparatus of the type mentioned initially such that an additional electric heater can be operated without increasing the number of bushings.

In order to solve this object, provision is made according to the invention for the electric heater to be in the form of a resistive heater and be connected in parallel with the superconducting windings, and for the heater current source to be an alternating current source which is connected to the external superconductor supply lines.

In order that the heaters do not bring about any notable additional losses during normal operation, they must have a higher resistance value than the superconducting field winding. In this case, however, it is not possible to simply choose a very high resistance value, in order to keep the additional losses as small as possible during operation of the cryostat, since as the resistance value increases, the heating power produced by the external alternating current source when heating up using a resistor decreases. According to the invention, the resistance of the resistive heater should thus be selected such that, during normal operation, the power loss produced owing to the operating DC voltage drop across the superconducting connection is markedly less than the heat loss performance of the cryostat, i.e. it is not the aim to have a loss close to zero.

Finally, it is also envisaged according to the invention to provide a switching device for connecting a direct current source to the external supply lines when the critical temperature of the superconducting windings is reached, with the result that, in addition to the resistive heater, the windings which are now no longer superconducting may also then be operated as a resistive heater.

Further advantages, features and details of the invention are given in the description below of an exemplary embodiment and with reference to the drawings, which schematically illustrate a three-phase synchronous motor having a superconducting rotor winding having an additional heater according to the invention.

Indicated in the external cryostat housing 1 is the rotor winding 2 which is illustrated only schematically and which is provided with direct current power supply lines 3, 4 which are led to the outside through bushings 5 and 6 of the housing and are connected to a DC voltage source 7.

In order to have means available to, if required, heat the cold part having a high thermal mass of such a three-phase synchronous motor rapidly, a resistive heater, i.e. a resistor 8, is provided according to the invention which is connected in parallel with the superconducting coil windings of the rotor 2. The power supply for heating purposes is provided by an alternating current source 9 which is connected to the external power supply connections 10 and 11 of the superconducting windings of the rotor 2.

Let us assume that, in a specific embodiment, the rotor has an inductance of 3 H. During operation, the voltage drop across the coil is typically below 1 V. A resistive heater 8 which is connected in parallel with the winding and is in the form of the resistor having a resistance value of 100 Ω thus brings about an additional power loss of below 10 mW and is thus negligible in comparison with the thermal losses of the cryostat of, for example, 30 W.

If heating is to be applied, for normal operation the alternating current source 9, which should have a frequency of, for example, 10 kHz, is connected to the power supply connections in place of the direct current source 7. For this frequency, the impedance of the winding of the rotor 2 is approximately 188 kΩ. It is thus easily possible for an AC voltage of 200 V to be applied to the connections, which results in the resistive heater 8 having a heating power of 400 W. Since this heating power is not dependent on the cold part temperature (in contrast to the thermal losses which are reduced as the temperature difference between the cold part and the surrounding temperature decreases), the heating time is reduced by more than the factor which results from the ratio of 400 W to 30 W. In this case, account should also be taken of the fact that in some circumstances even lower heating powers are desirable in order to prevent excessive thermal gradients in the cold part and associated mechanical loads, but this may be adjusted without any problems by reducing the applied voltage. As soon as the thermal gradients are no longer as great, a transition may easily be made back to a higher heating power which can be achieved automatically by a corresponding control program.

The apparatus according to the invention has the advantage that it is not absolutely necessary for completely new heating devices to be developed to supply the heating power but for recourse to be made, for example, to modified (tubular) power amplifiers from consumer electronics or ultrasound engineering. The abovementioned numerical values, in particular the frequency of the AC voltage, are only given by way of example. A value of 50 or 60 Hz, i.e. the system frequency, may also be used as the heater current source. In this example, approximately 10% of the heater current would then flow through the coil.

1-3. (canceled)

4. An apparatus, connectable to an external heater current source, for heating cold parts, having a high thermal mass and arranged in a thermally insulating cryostat housing, of a superconducting winding coupled to external superconducting supply lines, comprising:
an electric heater, disposed in the cryostat housing and connectable to the external heater current source, including a heating resistor connected in parallel with the superconducting winding, where the external heater current source is an alternating current source connected to the external superconducting supply lines.

5. The apparatus as claimed in claim 4, wherein the heating resistor has a power loss during normal operation produced owing to operating DC voltage drop across the superconducting winding, where the power loss is less than the heat loss performance of the cryostat housing.

6. The apparatus as claimed in claim 5, further comprising a switching device connecting a direct current source to the external supply lines when a critical temperature of the superconducting winding is reached.

7. The apparatus as claimed in claim 4, further comprising a switching device connecting a direct current source to the external supply lines when a critical temperature of the superconducting winding is reached.
